(19) United States
(12) Patent Application Publication
(10) Pub. No.: US 2007/0018801 A1
(43) Pub. Date: Jan. 25, 2007

(54) Digital voice/visual warning, alert, and status system for vehicles utilizing laser sensors

(76) Inventors: Steven J. Novotny, Colleyville, TX (US); Steven J. Novotny JR., Albuquerque, NM (US)

Correspondence Address: Steven J Novotny, 4205 Pembrooke Pkwy West, Colleyville, TX, 76034, US

(21) Appl. No.: 11/187,251

(22) Filed: Jul. 25, 2005

(51) Int. Cl. B60Q 1/00

(52) U.S. Cl. 340/435

(57) ABSTRACT

A Digital Voice/Visual Warning, alert, and status system (10) alerting an operator of an automotive vehicle of hazardous proximity or existence of vehicles in adjacent lanes utilizing commercial off the shelf laser technology. The system includes seven laser sensors mounted in 3 housings in strategic locations on the vehicle for direct frontal measurement (1s1), front and rear oblique presence (1s2, 1s3, 1s5, 1s6) and side presence (1s4, 1s7), the laser junction block (4) the command module (5) and power source, the turn actuator/system on/status module (6,7), and the digital voice/visual module (8). When the system is activated the laser sensors follow pre-coded protocols, the data is processed in the command module and sends the appropriate commands to the digital voice/visual module. The device relays digital voice audio and visual information for frontal distance and the presence or non-presence of vehicles in adjacent lanes when the turn signal (7) is activated.

The preset invention claims priority and hereby incorporated by reference in its entirety and claims the benefit of U.S. Provisional Application Ser. No. 60/589,856, filed Jul. 22, 2004.

The present invention relates generally to a digital voice and visual gauge alerting system, alerting the vehicle operator of potential dangerous distances in front of host vehicle or the presence of vehicles in adjacent lanes.

### BACKGROUND OF INVENTION

The present invention is a system that can be installed on a vehicle as an add-on device and operates independently from any control systems in the vehicle (ie brakes, acceleration control, warning flashers, etc). The present invention will alert the driver of vehicles directly in front if the distance is less than the recommended safe interval when in traffic and warn for potential impact. It will also alert the driver of vehicles that may not be seen when entering or merging into a lane of traffic, as well as determine the presence or non-presence of vehicles that may occupy an adjacent lane when changing lanes. With existing distractions that exist today such as audio systems, cell phones, entertainment systems, as well as vehicle design that limits visibility, drivers are challenged to operate their vehicles in a safe manner.

There are other devices that provide warnings in other manners, but do not employ the Digital Voice/Visual Warnings, detection methodology utilizing commercial off the shelf laser sensors, and safety logic and protocols incorporated in the computer program as well as designs in the associated hardware. The system also incorporates an open standard communication interface port that can utilize its process logic for extended safety functionality.

### SUMMARY OF THE DESCRIBED INVENTION

The foregoing and other advantages are provided by a method and components for alerting the operator of a vehicle that a potential hazardous condition exists. Once the system is activated it functions as an un-intrusive safety feature that runs in the operational background. The voice commands are only given when: the vehicle enters the programmed minimum threshold of proximity to the vehicle in front; a possibility of impact; the distance during merging into a stream of traffic (requires activation of the turn signal) detects the presence of another vehicle; or the turn signal is activated indicating the intention to move into the adjacent lane and a vehicle is present.

There is currently no device that incorporates the configuration of the components as applied in the manner of the invention along with a viable method for alerting the (often distracted or inattentive) driver by digital voice commands or visual representation as shown on the safety gauge.

One of the several advantages of the invention is that it incorporates cost effective commercial off the shelf lasers that safely monitor multiple fields of vision. It's also based on open standard computer code and may be modified or upgraded through the change of an accessible ASIC chip in the systems command module. The system may be an OEM device or added as an aftermarket installation. The invention has the potential for preventing accidents and bodily injury.

Hereby the invention specifies a digital voice warning and a visual safety gauge that is determined by the conditions defined in 3 protocols and the instructions incorporated in the systems computer code residing in the command module. The electronic circuitry that processes data from the seven sensors strategically positioned on the vehicle is commercial off the shelf laser technology. The laser sensors are mounted on the front and side/rear of the vehicle and are continuously monitoring distances, direct frontal, front oblique, side, and rear oblique when the system is “ON”. The front oblique, side, and rear oblique laser sensors are activated by the “turn signal” either right or left side.

### BRIEF DESCRIPTION OF THE DRAWINGS

The drawings attached provide further details of the invention, the components, sample applications, open standard code, and functionality as described below.

FIG. 1 shows in a schematic block diagram form the logic and functionality for the digital voice alert and visual gauge system.

FIG. 2 shows mounting locations of components of the system

FIG. 3 shows components of the system

FIG. 4 shows vehicle in traffic analyzing intervals and detecting if a hazardous distance in the vehicle directly in front exists or the possibility of impact based on the speed of both vehicles

FIG. 5 shows vehicle entering on ramp of a divided highway

FIG. 6 shows vehicle in traffic, activating turn signal to determine adjacent lane status

FIG. 7 shows outline for code that is executed when the system is activated and measures intervals and impact probability

FIG. 8 shows outline for code that is executed when the turn signal is activated and determines presence or non-presence

### DETAILED DESCRIPTION OF PREFERRED EMBODIMENTS

The use of the invention is intended to be an ancillary method of hazard notification while operating a vehicle under normal driving conditions. It as not intended to be a substitution for an operator's judgment in controlling, decision-making, or maneuvering their vehicle. The method in accordance to the invention identifies and alerts the operator in an audible and visual manner of other vehicles that may be in hazardous proximity or in blind spots under normal operations or when desiring to change lanes.

The components described in the following, are “commercial off the shelf (COTS)” laser components that operate under recognized safety guidelines and electronic and microprocessor based systems illustrated as examples.

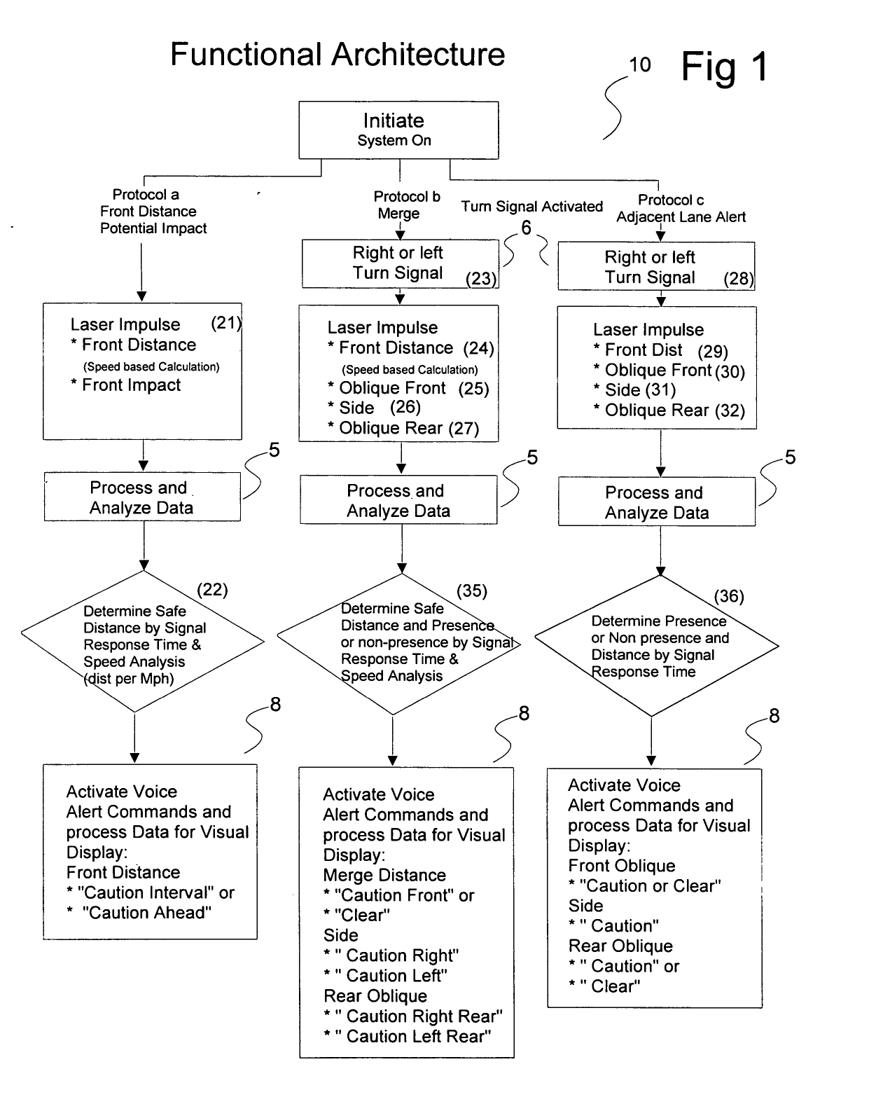

FIG. 1 shows in the form of a block diagram the functional architecture of the invention. The device (10) comprised of the selector module (6) that is mounted on the steering column and is attached to the turning signal (7), when turned to the on position activates the system and initiates the power source to apply current to the command module (5), all circuitry associated with lasers (1), and digital voice/visual module (8) in standby mode.

In protocol a—frontal distance—the laser is in a continuously active mode sensing the distance of the vehicle directly in front. If the vehicle directly in front of host vehicle become closer than the programmed safe interval or the speed of the host vehicle as analyzed by the program indicates the probability of impact the data is processed and the program code instructs the digital voice/visual module to initiate the “Caution Ahead” or “Caution Interval” via the digital voice file and process data to the safety gauge.

In protocol b—merge protocol—the lasers in the front, side, and rear are activated when the turn signal is selected indicating the desire to merge into a lane. The lasers are sensing oblique front, side, and oblique rear to determine presence or non-presence of a vehicle. If a vehicle is detected by the lasers directly in front oblique of host vehicle and is closer that the safe distance as written in the program the data is processed and the program code instructs the digital voice/visual module to initiate the “caution front” or if no vehicle is present “clear” voice file and process data in the safety gauge. If a vehicle is detected by the lasers directly on the side of host vehicle the program data is processed and the program code instructs the digital voice/visual module to initiate the “Caution Right or Caution Left” or if no vehicle “Clear” via the digital voice file and process visual representation in the safety gauge. If a vehicle is detected by the lasers oblique rear of host vehicle the program data is processed and the program code instructs the digital voice/visual module to initiate the “Caution Right Rear or Caution Left Rear” or if no vehicle “Clear” via the digital voice file and process visual representation in the safety gauge.

In protocol c—lane change protocol—the lasers in the front, side, and rear are activated when the turn signal is selected indicating the desire to change into adjacent lane. The lasers are sensing oblique front, side, and oblique rear to determine presence or non-presence of a vehicle. If a vehicle is detected by the lasers front oblique of host vehicle and is closer that the safe distance as written in the program the data is processed and the program code instructs voice module to initiate the “Caution” or if no vehicle “Clear” via the digital voice file and process visual representation in the safety gauge. If a vehicle is detected by the lasers directly on the side of host vehicle the program data is processed and the program code instructs digital voice/visual module to initiate the “Caution” or if no vehicle “Clear” via the digital voice file and process visual representation in the safety gauge. If a vehicle is detected by the lasers oblique rear of host vehicle the program data is processed and the program code instructs voice module to initiate the “caution” or if no vehicle “clear” via the digital voice file and process visual representation in the safety gauge.

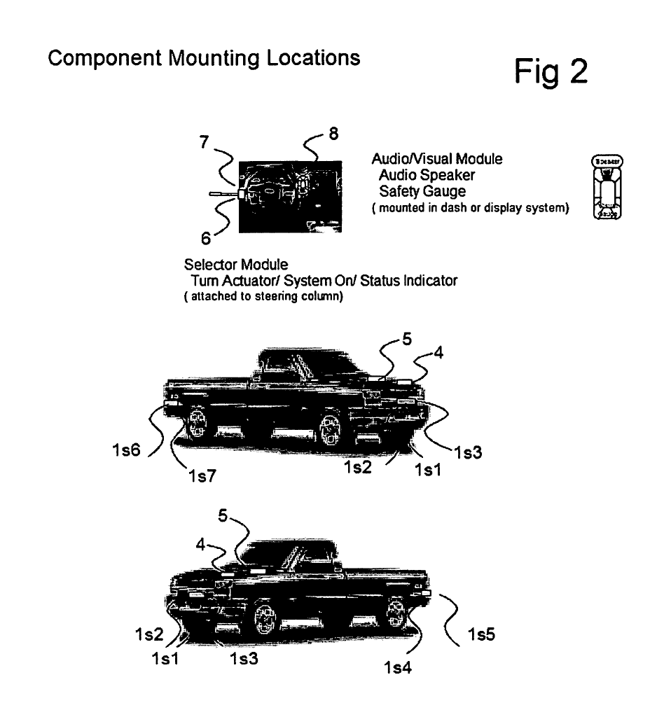

FIG. 2 describes the locations of the components mounted on utility vehicles and the digital voice/visual module (and safety gauge). The system also be installed on passenger and large commercial vehicles.

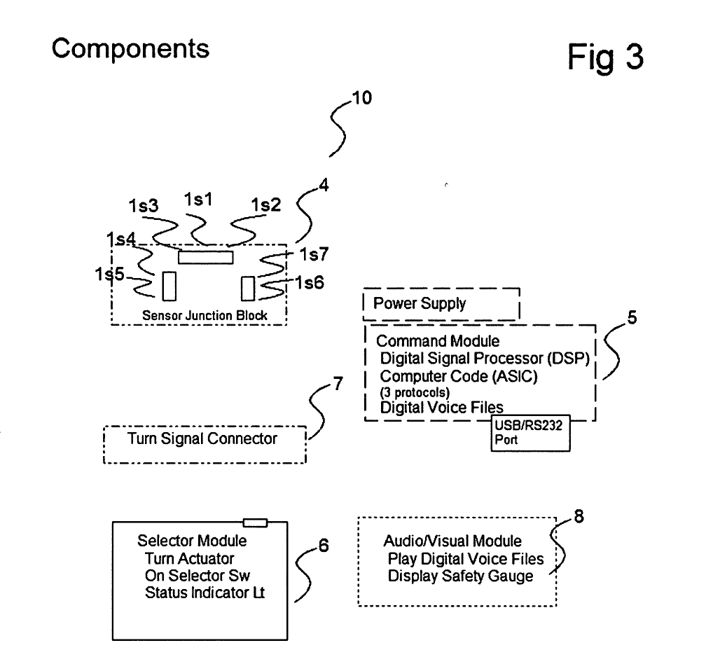

FIG. 3 describes the components of the invention and the required connectivity.

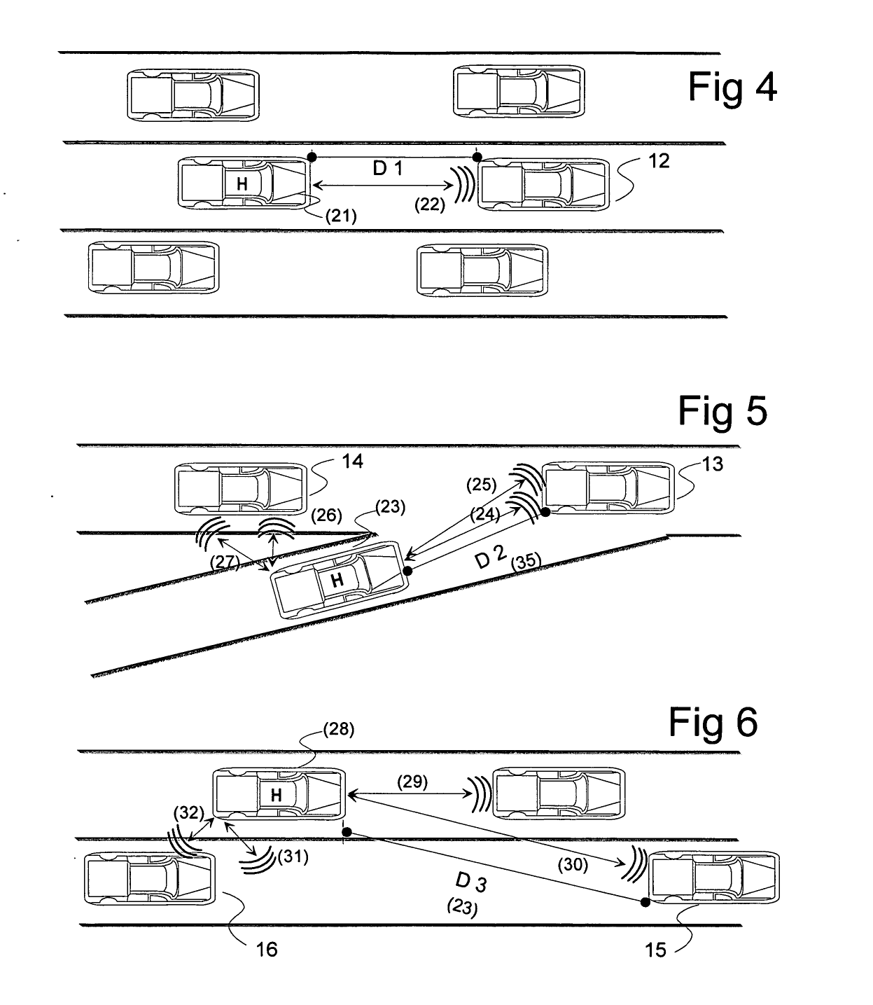

FIG. 4 describes the host vehicle (21) with the system ON traveling in traffic, whereby the laser 1s1 (22) projects and infrared beam at the programmed rate, the data is processed per “protocol a”, and the speed and distance of vehicle (12) that is directly in front is analyzed to determine if it is less than the safe interval—10 ft per 10 mph (or other determined safety interval) (34). If the analyzed data determines the front vehicle is traveling at a rate slower than the host vehicle or the distance d1 is below the acceptable minimal space a warning, alert, and status signal is then sent to the digital voice/visual module with the appropriate digital voice command and visual representation in the safety gauge.

FIG. 5 describes the host vehicle merging in a traffic lane with system on, the turn signal (23) is activated indicating a left merge, whereby the lasers 1s1(24), 1s3(25), 1s4(26), 1s5(27), emits a pulse at the programmed rate, the data is processed per “protocol b”, and the speed and distance of vehicle (13) that is directly and obliquely in front is analyzed by lasers 1s1 (24) and 1s3(25), the presence of vehicle (14) that is in a position to the side and obliquely rear is analyzed by lasers 1s4(26) and 1s5(27). If the analyzed data determines the front vehicle is traveling at a rate slower than the host vehicle or the distance d2(35) is below the acceptable minimal space for safely merging or vehicle (14) is present a warning, alert, and status signal is then sent to the digital voice/visual module with the appropriate digital voice command and visual representation in the safety gauge.

FIG. 6 describes the host vehicle traveling in a traffic lane with system ON, the turn signal (28) is activated indicating the desire to change to the adjacent right lane, whereby the lasers 1s1(29), 1s2(30), 1s6(31), 1s7(32), emits a pulse at the programmed rate, the data is processed per “protocol c”, and the presence of vehicle (15) that is obliquely to the front right is analyzed by laser 1s2, the presence of vehicle (16) that is in a position to the side and obliquely rear is analyzed by lasers 1s6 and 1s7. If the analyzed data determines the front oblique vehicle (15) is present and is closer than the acceptable minimal space d3(36) required to safely change lanes or vehicle (16) is present, a warning, alert, and status signal is then sent to the digital voice/visual module with the appropriate digital voice command and visual representation in the safety gauge.

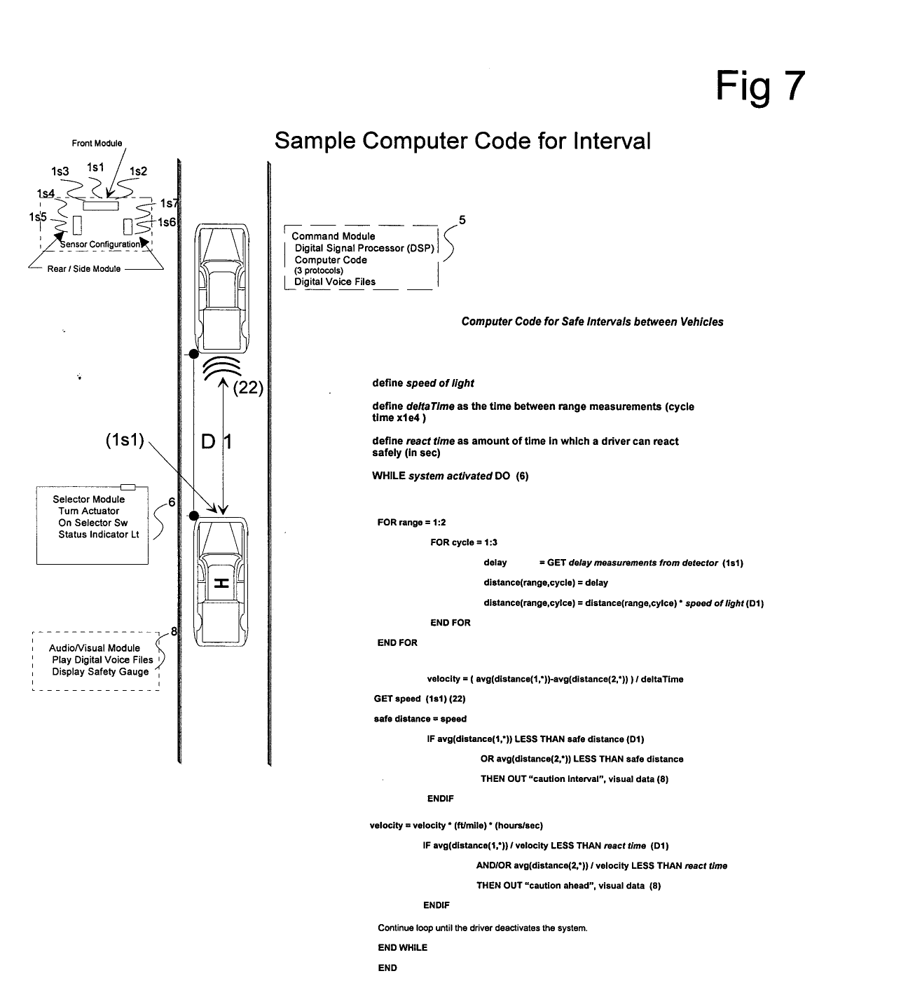

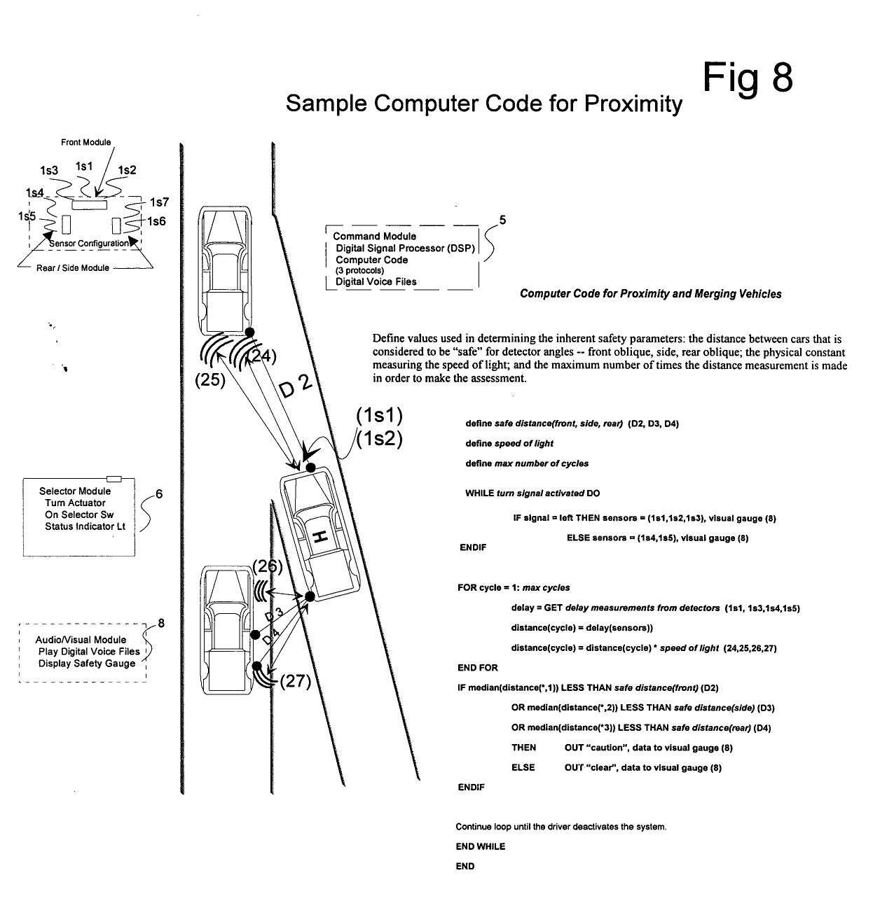

FIG. 7 describes the computer code wherein the prescribed distance is measured for safe intervals as well as speed of vehicles that would indicate the probability of impact and executes the command for the appropriate alert digital voice files and data that displays visual representation in the safety gauge.

FIG. 8 describes the computer code wherein merging in traffic determines presence or no-presence and executes the command for the appropriate alert digital voice files and data that displays visual representation in the safety gauge.

Protocols written in the code and as described in the embodiments of the invention provides the instructions to the laser sensor complex, analyzes data from the laser sensors, activates the appropriate instructions per the functional requirements of the protocol, and processes the data in the form of executable digital voice files and visual representation in the safety gauge in the digital voice/visual module.

The present invention has been described here using specific embodiments and examples, but is not for that reason limited to these.

What is claimed is:

1. A Digital Voice/Visual Warning system alerting the driver of the presence of vehicles occupying close proximity or occupying adjacent lanes based on projecting and sensing measurements utilizing commercial off the shelf (COTS) laser technology. The system is comprised of: Commercial off the shelf lasers located in 3 housings with 7 sensing fields on host vehicle, directed at specific areas providing data.

2. A system as in claim 1 connected to an electronic microprocessor command module that processes computer code written with specific algorithms; when the vehicle approaches close proximity or the turn signal is activated; data provided by laser sensors and processed in the command module, are relayed to the digital voice/visual module, and digital voice files and visual gauge is activated providing audio and visual alerts to the driver.

3. A system as in claim 2, when system is activated that in turn accesses the requested protocol and analyzes data from laser sensors to alert the vehicle operator of potential hazardous conditions, connected to the command module, associated laser sensors, and digital voice/visual module to convey digital voice alerts and visual representation of proximity status.

4. A system as in claim 2, wherein the space between the host vehicle and a vehicle directly in front is analyzed and digital voice alert files are executed and data processed to provide visual alerts in accordance with recommended intervals (or adjusted safety intervals) based on the traveling speed, computer code written for 10 feet per 10 mph “safe interval”. Wherein the distance between vehicles is less than the safe interval when in traffic a digital voice command of “Caution Interval” and a visual alert is shown on the safety gauge, or when an estimated impact is calculated based on the vehicle speed of both vehicles a digital voice command of “Caution Ahead” via the digital voice/visual module alerts the operator.

5. A system as in claim 2, wherein the turn signal is activated the appropriate laser sensor following instructions from the computer code analyzes vehicle distance, presence, or non-presence of oblique front, side, oblique rear, and frontal space when merging or changing lanes, wherein a digital voice command of “Caution” or “Clear” and visual alert is shown on the safety gauge, via the digital voice/visual module alerts the operator of the host vehicles that a vehicle is present or the proximity for changing to adjacent lane is unsafe.

6. A system as in claim 1 further comprised of electronic circuitry that provides for open standard interface port to aid in further developing safety control systems that would utilize the safety logic incorporated in the computer code.
